(19) United States
(12) Patent Application Publication
(10) Pub. No.: US 2009/0317598 A1
(43) Pub. Date: Dec. 24, 2009

(54) PLATE EQUIPPED WITH AT LEAST ONE CURVED EDGE AND MANUFACTURING METHOD FOR SUCH A PLATE

(76) Inventors: Olivier Delafon, Luxeuil Les Bains (FR); Abderrahim Rachidia, Luxeuil Les Bains (FR)

Correspondence Address: GREENBLUM & BERNSTEIN, P.L.C., 1950 ROLAND CLARKE PLACE, RESTON, VA, 20191, US

(21) Appl. No.: 12/374,930

(22) PCT Filed: Jul. 26, 2007
(86) PCT No.: PCT/FR2007/001284

§ 371 Date: Jan. 23, 2009

(30) Foreign Application Priority Data
Aug. 11, 2006 (FR) 0607282

(51) Int. Cl. B32B 3/00; B29C 47/06

(52) U.S. Cl. 428/189; 264/171.13; 264/138

(57) ABSTRACT

Plate equipped with at least one curved edge and manufacturing method for such a plate The method of manufacturing plates equipped with at least one curved edge according to the invention, from an extrudate (11) that is hot-extruded between two sheets (7,8), the whole being then calendared, is in particular remarkable in that two sheets (7,8) of different widths are used and that the material is extruded so as to cover roughly the whole surface of the wider sheet (7) over the edge of narrower sheet (8) on at least one side thus constituting at least one longitudinal edge (17a, 17b) formed by the wider sheet (7) covered only by the extrudate (11), said edge then curving without other interventions, by natural mechanical constraints during manufacturing, so as to be concave on the narrower side of sheet (7). The invention also relates to as such a plate formed from a core in thermoplastic material sandwiched between two sheets (7,8) of which one (8) is narrower, constituting at least one longitudinal edge (17a, 17b) formed by the wider sheet (7) covered only by the thermoplastic material (11), said edge(17a, 17b) being curved so as to be concave on the side of the narrower sheet (8).

The invention relates to a method for manufacturing plates provided with at least one curved edge.

The invention also relates to a plate having such a curved edge, to be used in particular as carrying support for a fork-lift truck of the carriage type or other.

It is well known to transport goods or products from one warehouse to another, or from a warehouse to a vehicle, or vice versa, by means of wooden pallets and fork-lift trucks, the goods being positioned on said pallets.

In order to limit the use of wood and/or to save space and/or to reduce the weight, one has sought to replace the conventional wooden pallet, although it has become a means which could appear impossible to circumvent.

Thus, the inventors have sought novel means in the form of plates having curved edges, to enable the forks of the fork-lifts truck to be easily inserted beneath said plates.

To obtain plates of this type, various techniques, such as slotting, for example, can be envisioned, which make it possible to curve the edges; however, the inventors have discovered a completely original and surprising method to achieve the same result.

The method for manufacturing plates provided with at least one curved edge according to the invention starts with a material that is hot-extruded between two sheets, the whole then being calendered as described, for example, in the document 2.528.350 A.

The method according to the invention is characterized in that two sheets of different widths are used, and that the material is extruded so as to cover substantially the entire surface of the wider sheet by overlapping the narrower sheet on at least one side, thus constituting at least one longitudinal edge formed by the wider sheet covered only with the extrudate, said edge then curving by natural mechanical constraint, without any other intervention, during manufacturing, so as to be concave on the side of the narrower sheet.

The invention further proposes a continuous method, as in the aforementioned document, in which the two sheets of different widths are sheets unrolled into bands, the whole being cut transversely after the calendering operation.

For example, at least the edge formed by the wider sheet covered only with the extrudate is trimmed mechanically to form an even edge and/or to size the final product more precisely.

According to one embodiment, the two sheets have the same longitudinal central axis so as to form two curved longitudinal edges.

According to various embodiments or characteristics, calendering is carried out at controlled temperature and/or the assembly is cooled by air after calendering and/or the extrudate comes from a thermoplastic mixture and/or the sheets are sheets of strong paper.

Naturally, and in a general fashion, the invention also relates to a plate provided with at least one curved edge, constituted by a thermoplastic material core sandwiched between two sheets, which is characterized in that one of the sheets is narrower, such that the thermoplastic material covers the entire surface of the wider sheet by overlapping the narrower sheet on at least one side, thus constituting at least one longitudinal edge formed by the wider sheet covered only with the thermoplastic material, said edge being curved so as to be concave on the side of the narrower sheet.

As mentioned previously, a particularly advantageous application of a plate according to the invention is for use as a carrying support plate for a fork-lift truck, the curved edge(s) promoting the insertion of the forks under said plate.

However, the above mentioned application should not be limiting, since the invention applies to all uses of such a plate provided with at least one curved edge.

The invention will be readily understood upon reading the description that follows, with reference to the annexed drawings, in which:

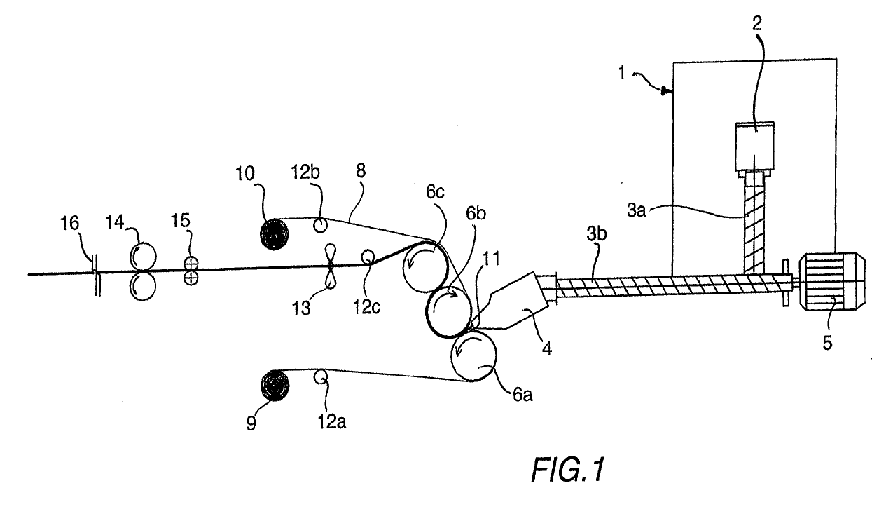

FIG. 1 schematically shows a production line, which makes it possible to describe the method according to the invention,

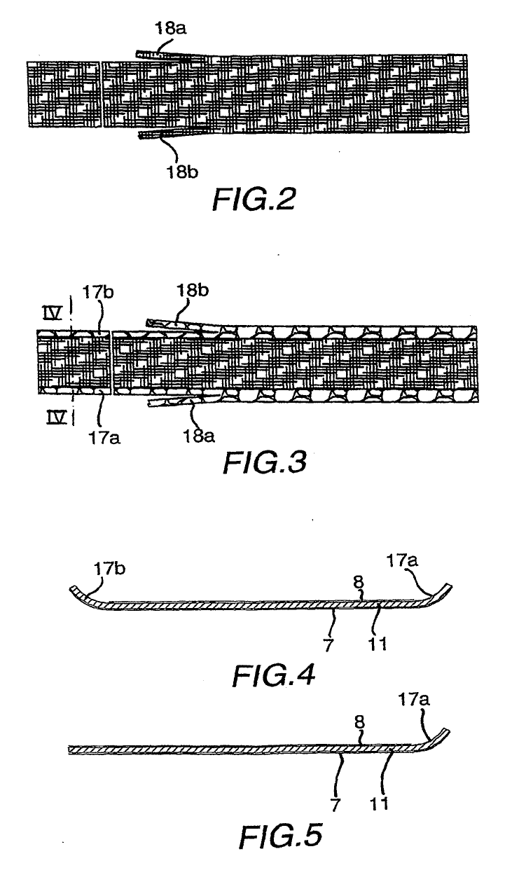

FIG. 2 is a planar bottom view of the product upon exit from the product line,

FIG. 3 is a planar top view of the product upon exit from the product line,

FIG. 4 shows the final product in transverse cross-section along the line IV-IV of FIG. 3,

FIG. 5 shows a final product in the same manner as FIG. 4, but according to another embodiment.

FIG. 1 shows a production line for a product according to the invention, which comprises an extrusion machine 1 provided with a feed hopper 2, two pressure-applying screws 3a, 3b for carrying the product, a die 4 and a motor 5.

The die 4 emerges between two rollers 6a, 6b of a calender provided with a third roller 6c at the outlet, said calender further having controlled temperature.

The rollers 6a, 6b, which turn in opposite directions, and which are substantially in contact or almost in contact with one another, are fed by sheets 7 and 8 in bands coming from reels 9 and 10, respectively, such that the material upon exit from the die or extrudate 11 is extruded between the two sheets 7 and 8 which are partially wound around the rollers 6a, 6b, as shown clearly in FIG. 1.

Thus, it is understood that the extrudate 11 is inserted between the two sheets, and that upon exit from the roller 6c of the calender, one has a complex formed of an extrudate 11 inserted between two sheets 7 and 8.

The material that supplies the hopper 2 is, for example, a thermoplastic material of the type described in the aforementioned document 2528350 A, but it could be any other material capable of being hot softened, and of hardening at least partially while cooling; this material could even be at least partly natural.

The sheets 7 and 8 in bands, for example, can be made of strong paper of the kraft type.

The device shown, in addition to certain guiding rollers such as 12a, 12b, 12c, also has, downstream from the calender and in order, an air cooling system 13, a station 14 for pulling the complex, a station 15 for trimming the clippings, which will be discussed hereinafter, and a transverse cutting station 16.

As further shown clearly in FIGS. 2 to 5, the sheet 8 in band is narrower than the sheet 7 in band, the two sheets being further centered in FIGS. 3 and 4, i.e. with superposition of their longitudinal axis.

This way, as shown clearly in FIG. 3, the extrudate 11, which is arranged over substantially the entire width of the sheet 7, then overlaps to make two edges 17a, 17b, formed of the sheet 7 covered only with the extrudate 11, therefore excluding a portion of the sheet 8.

The extrudate 11, already partially cooled in the calender, and then in the station 13, solidifies the complex thus formed, the edges of which are partially trimmed at the cutting station 15 to even up the edges and/or to size the final product more precisely, the resulting clippings 18a, 18b (FIGS. 2 and 3) being eliminated.

Due to fact that two sheets 7 and 8 of different widths are used, the edges 17a and 17b curve, as shown clearly in FIG. 4, by mechanical constraint, without any other intervention.

Perhaps, this surprising mechanical constraint comes from tension exerted on the edges when the material is cooling off, tension that curves the edges so as to be concave on the side of the narrower sheet 8; this curving can be observed in particular in the cooling phase, between the exit from the calender (6a, 6b, 6c) and the pulling station 14.

It is clear that if one chooses to make only one curved edge, it suffices to adjust one of the edges of the sheet 8 to the corresponding edge of the sheet 7 in order obtain a final product of the type shown in FIG. 5, having only one curved edge 17a.

The method that has just been described herein relates to a continuous manufacturing process, but one can obviously envision manufacturing per unit, the sheets sized for this purpose being neither in reel, nor cut.

Furthermore, as mentioned previously, the invention also relates to each such plate, i.e., manufactured as described hereinabove, or possibly manufactured differently, but constituted, as specified hereinabove, by a thermoplastic material core sandwiched between two sheets, in which one of the sheets is narrower, such that the thermoplastic material covers the entire surface of the wider sheet by overlapping the narrower sheet on at least one side, thus constituting at least one longitudinal edge formed by the wider sheet covered only with the thermoplastic material, said edge being curved so as to be concave on the side of the narrower sheet.

Similarly, such plates can advantageously be used as carrying supports for fork-lift trucks, but such a use is not limiting.

1. Method for manufacturing plates provided with at least one curved edge, from an extrudate (11) that is hot-extruded between two sheets (7, 8), the whole being then calendered, characterized in that two sheets (7, 8) of different widths are used, and that the material is extruded so as to cover substantially the entire surface of the wider sheet (7) by overlapping the narrower sheet (8) on at least one side, thus constituting at least one longitudinal edge (17a, 17b) formed by the wider sheet (7) covered only with the extrudate (11), said edge then curving by natural mechanical constraints, without any other intervention, during manufacture, so as to be concave on the side of the narrower sheet (7).

2. Method of continuous manufacturing according to claim 1, characterized in that the two sheets (7, 8) of different widths are sheets unrolled into bands, the whole transversely cut (15) after the calendaring operation.

3. Method of manufacturing according to claim 1, characterized in that at least the edge (17a, 17b) formed by the wider sheet (7) covered only with the extrudat (11) is trimmed mechanically (15) to form an even edge and/or to size the final product more precisely.

4. Method of manufacturing according to claim 1, characterized in that the two sheets (7, 8) have the same longitudinal central axis so as to form two curved longitudinal edges (17a, 17b).

5. Method of manufacturing according to claim 1, characterized in that calendering is carried out at controlled temperature.

6. Method of manufacturing according to claim 1, characterized in that the whole is cooled (13) by air after calendering.

7. Method of manufacturing according to claim 1, characterized in that the extrudate (11) comes from a thermoplastic mixture.

8. Method of manufacturing according to claim 1, characterized in that the sheets (7, 8) are sheets of strong paper.

9. Plate provided with at least one curved edge, constituted by a thermoplastic material core (11) sandwiched between two sheets (7, 8), characterized in that one (8) of the sheets is narrower, such that the thermoplastic material covers the entire surface of the wider sheet (7) by overlapping the narrower sheet (8) on at least one side, thus constituting at least one longitudinal edge (17a, 17b) formed by the wider sheet (7) covered only with the thermoplastic material (11), said edge (17a, 17b) being curved so as to be concave on the side of the narrower sheet (8).

10. Application of the plate according to claim 9 as a carrying support plate for a fork-lift truck, the curved edges promoting the insertion of the forks under said plate.
